(19) United States
(12) Patent Application Publication
(10) Pub. No.: US 2008/0076015 A1
(43) Pub. Date: Mar. 27, 2008

(54) ELECTRONIC DEVICE

(75) Inventors: Chih Wei Tien, Chiayi County (TW); Kuan Hsu Lin, Taipei County (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/782,582

(22) Filed: Jul. 24, 2007

(30) Foreign Application Priority Data
Sep. 26, 2006 (TW) TW95135501

(51) Int. Cl. H01M 2/04

(52) U.S. Cl. 429/100

(57) ABSTRACT

An electronic device comprises a main body, a cover joined to the main body capable of opening and closing, a latching module disposed on the cover and engaging the main body to close the cover, and an elevating-rotating mechanism connecting the main body and the cover. When the latching module engages the main body, the cover is closed and fixed to the main body. When the latching module is released from the main body, the elevating-rotating mechanism lifts the cover from the main body to an appropriate distance and the cover is rotated by an appropriate angle with respect to the elevating-rotating mechanism.

### BACKGROUND OF THE INVENTION

1. Field of the Invention

The invention relates to an electronic device, and in particular relates to an electronic device with a cover capable of lifting and rotating.

2. Description of the Related Art

When a battery of a conventional notebook is replaced, the cover of the battery compartment must be first be opened and removed from the laptop. Opening and removing the cover may be difficult and the separated cover may be lost.

### BRIEF SUMMARY OF INVENTION

Electronic devices are provided. An exemplary embodiment of an electronic device comprises a main body, a cover joined to the main body capable of opening and closing, a latching module disposed on the cover and engaging the main body to close the cover, and an elevating-rotating mechanism connecting the main body and the cover. When the latching module engages the main body, the cover is closed and fixed to the main body. When the latching module is released from the main body, the elevating-rotating mechanism lifts the cover from the main body to an appropriate distance and the cover is rotated by an appropriate angle with respect to the elevating-rotating mechanism.

The latching module comprises a first spring and a latching member having a hook and a first post to which the first spring is joined to bias the latching member and enable the hook to engage the main body. The main body has a channel with which the hook engages.

The elevating-rotating mechanism comprises a base disposed on the main body, a movable member movably disposed on the base, a second spring biasing the movable member, a shaft disposed on the movable member, moving with the movable member and joined to the cover rotating with respect to the shaft. When the latching module is released from the main body, the second spring biases the movable member to move on the base and lift the cover to the appropriate distance, whereby the cover rotates to the appropriate angle with respect to the shaft.

The elevating-rotating mechanism further comprises a seat disposed on the movable member and has a second post to which the second spring is joined to bias the seat.

The base has an opening in which the movable member moves. The cross section of the movable member has substantially the same profile as the opening.

The movable member has a curved portion, a linear portion connected to the curved portion and a flange projected from the linear portion, wherein the shaft is accommodated in the curved portion, and the linear portion is movably joined to the base, and the flange abuts the base to limit the movable member. The elevating-rotating mechanism further comprises a seat disposed on the movable member and has a second post to which the second spring is joined to bias the seat. The linear portion comprises a long groove having an end, and the seat further has a third post disposed in the long groove, and the second spring biases the seat to enable the third post to abut the end.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a perspective view of an electronic device of the invention;

FIG. 2a is a schematic view of a latching module of the invention;

FIG. 2b is an enlarged view of region A of FIG. 2a;

FIG. 2c is a perspective view of the latching module of the invention;

FIG. 3a is a perspective view of an elevating-rotating mechanism of the invention;

FIG. 3b is an exploded view of an elevating-rotating mechanism of the invention;

FIGS. 4 and 5 depict the elevating-rotating mechanism connecting the main body and the cover, wherein FIG. 4 depicts the cover in the closed position and FIG. 5 depicts the cover in the opened position;

FIGS. 6-8 depict the cover lifted and rotated; and

FIGS. 9-11 depict the cover lowered and closed.

### DETAILED DESCRIPTION OF INVENTION

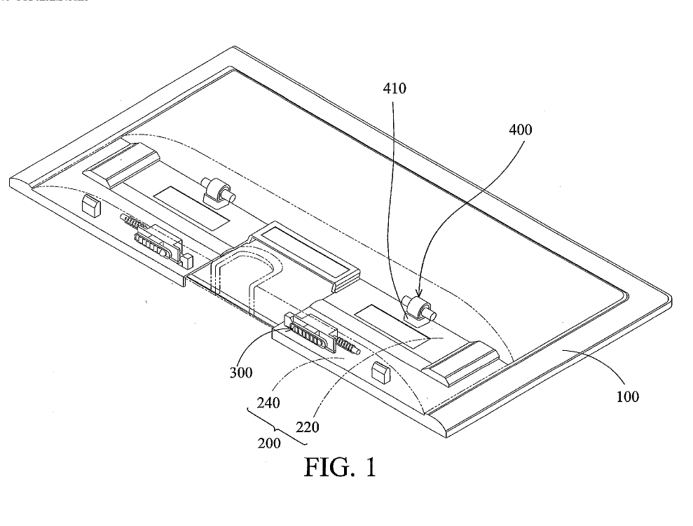

Referring to FIG. 1, an electronic device 1000 comprises a main body 100, a cover 200, two latching modules 300 and two elevating-rotating mechanisms 400. The cover 200 has a bottom 220 and a lateral side 240 and is joined to the main body 100 and is capable of closing and opening. A space formed between the cover 200 and the main body 100 accommodates a battery. The latching module 300 disposed on the lateral side 240 can engage the main body 100 to secure the cover 200 to the main body 100. The elevating-rotating mechanism 400 connects the cover 200 and the main body 100. As the elevating-rotating mechanism 400 is connected to the edge of the bottom 220, when the engagement of the latching module 300 and the main body 100 is released, the cover 200 is lifted from the main body 100 to an appropriate distance and rotated by an appropriate angle. The structures of the latching module 300 and the elevating-rotating mechanism 400 are described in the followingin the following.

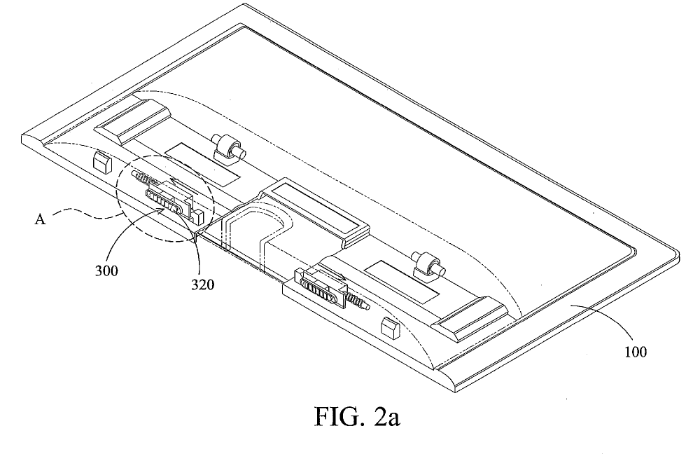

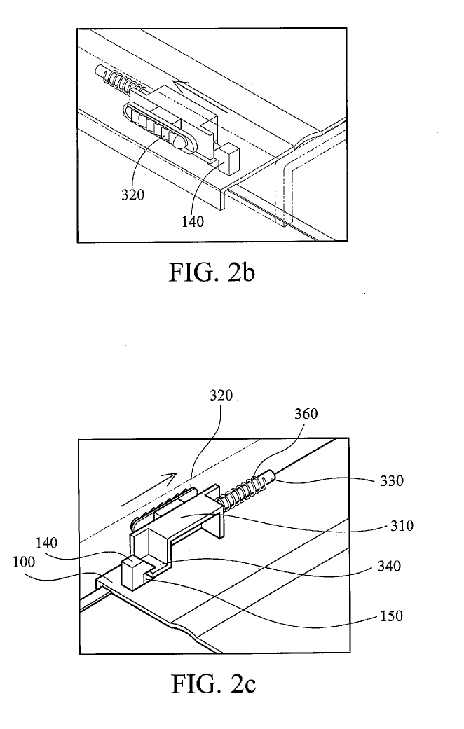

Referring to FIGS. 2a, 2b and 2c, the latching module 300 is disposed on the lateral side 240 and has a pushing portion 320. When the pushing portion 320 is pushed in the direction shown by the arrow in FIG. 2a, the latching module 300 is disengaged from the main body 100. Referring to FIG. 2c, the latching module 300 comprises a main body 310, a pushing portion 320, a first post 330, a hook 340 and a first spring 360. The main body 310 is rectangular. The pushing portion 320 is disposed on one side of the main body 310, and the hook 340 is disposed on another side of the main body 310. The first post 330 extends from one side of the main body 310. The first spring 360 is a compression spring and joined to the first post 330 to bias the main body 310. A hook 140 is disposed on the main body 100 to form a channel 150. The hook 340 enters the channel 150 and is positioned therein by the potential of the first spring 360, whereby the cover 200 is closed. When the pushing portion 320 is pushed in the direction shown by the arrow in FIG. 2a, the hook 340 is released from the channel 150, whereby the engagement of the latching module 300 and the main body 100 is released.

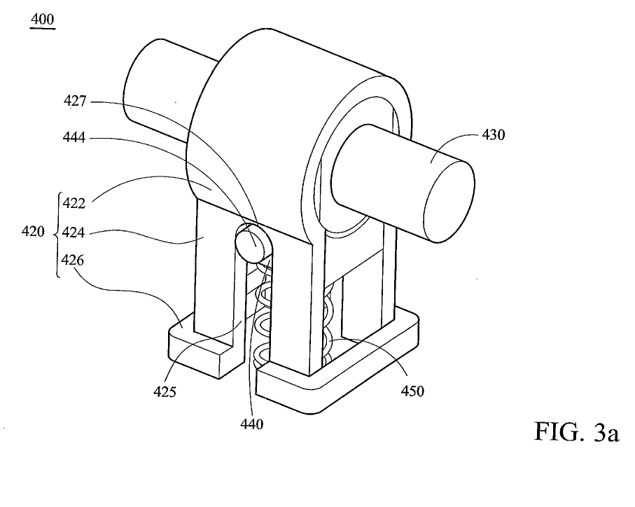

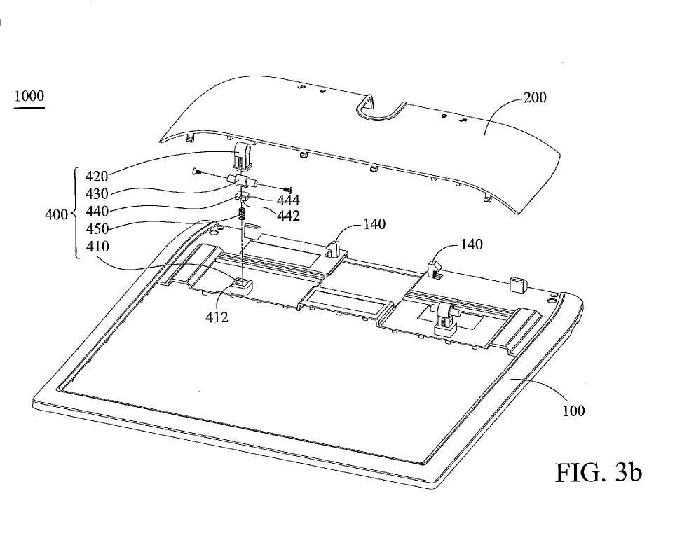

Referring to FIGS. 3a and 3b, the elevating-rotating mechanism 400 comprises a base 410, a movable member 420, a shaft 430, a seat 440 and a second spring 450. An opening 412 is formed at the top of the base 410. The movable member 420 is movably disposed on the base 410 via the opening 412. The movable member 420 comprises a curved portion 422, a linear portion 424 and a flange 426. The shaft 430 is held in the curved portion 422. The linear portion 424 is connected to the curved portion 422 and moves in the base 410 through the opening 412. The flange 426 projecting from the linear portion 424 abuts the top of the base 410 to limit movement of the movable member 420. The cross sectional profile of linear portion 424 is the same as the opening 412. The seat 440 is embedded in the linear portion 424 and comprises a first post 442 and a third post 444. The second spring 450 is a compression spring and holds the post 442 to bias the seat 440 and further bias the movable member 420. A long groove 425 is formed on one side of the linear portion 424. The long groove 425 has an end 427. The third post 444 engages the long groove 425 and abuts the end 427 by the potential of the second spring 450, whereby the seat 440 is positioned.

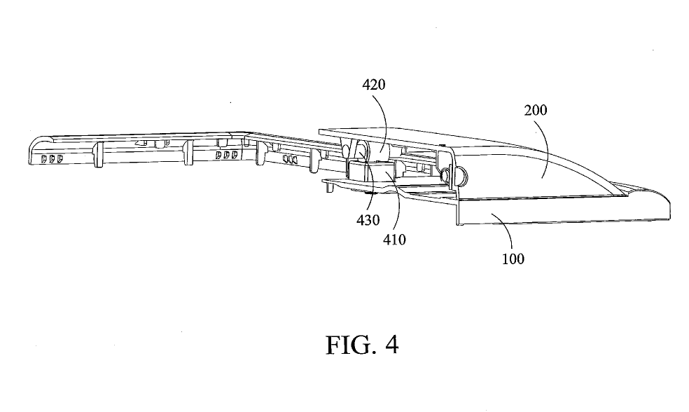

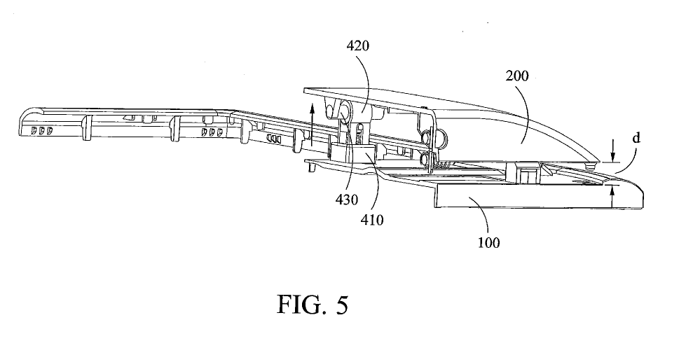

Referring to FIGS. 4 and 5, the cover 200 is rotatable with respect to the shaft 430, and the movable member 420 moves perpendicular to the main body 100. When the latching module 300 is disengaged from main body 100, the movable member 420 is lifted to an appropriate distance d by the potential of the second spring 450. The movement of the cover 200 is described in the following.

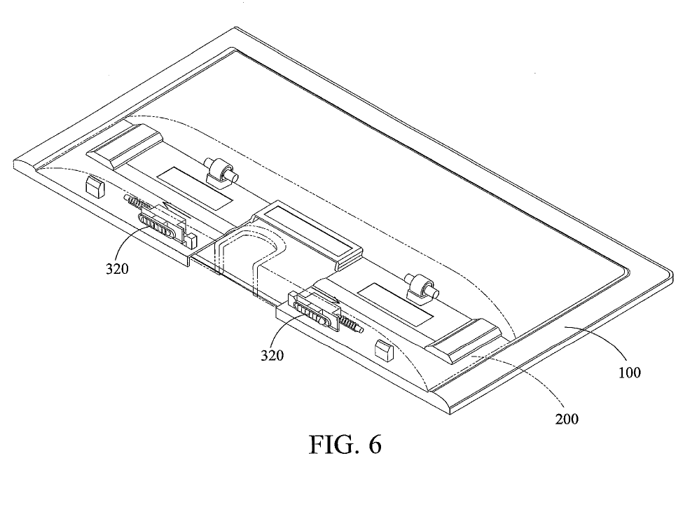

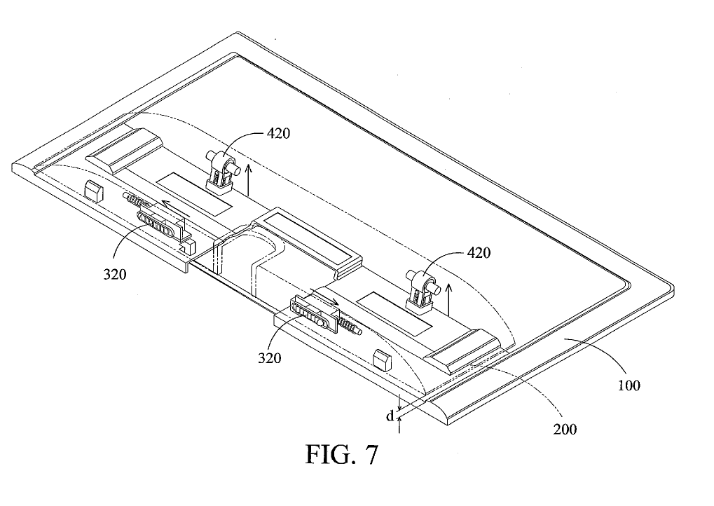

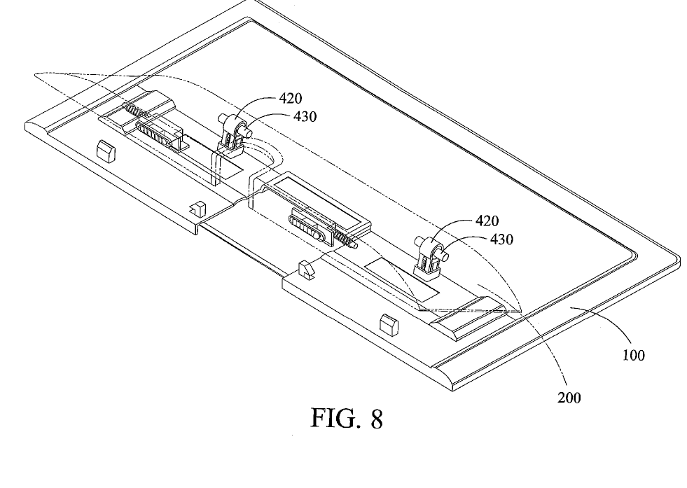

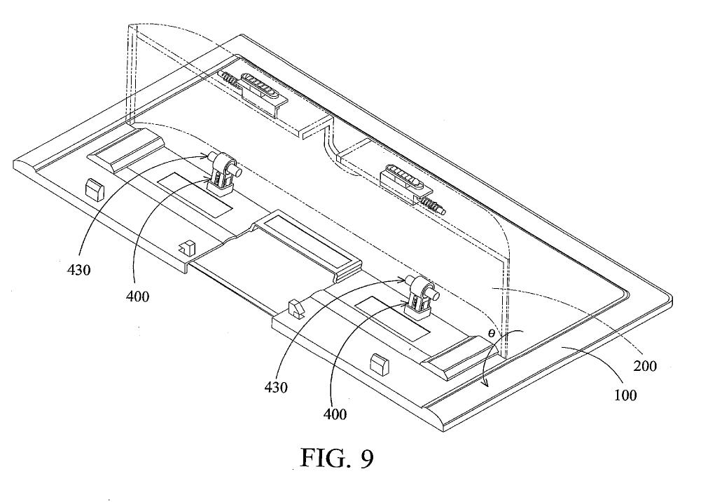

FIGS. 6 to 11 depict the movement of the cover 200. When the latching module 300 engages the main body 100, the cover 200 is secured to the main body 100 as shown in FIG. 6. When the pushing portion 320 is pushed, the latching module 300 is disengaged from the main body 100. The second spring 450 lifts the movable member 420 to the distance d until the flange 426 abuts the base 410. At this time, the position of the cover 200 is defined as a first position as shown in FIG. 7. The cover 200 is rotated with respect to the shaft 430 by an appropriate angle θ as shown in FIG. 8 to a second position as shown in FIG. 9. When the cover 200 is in the second position, the battery can be easily replaced.

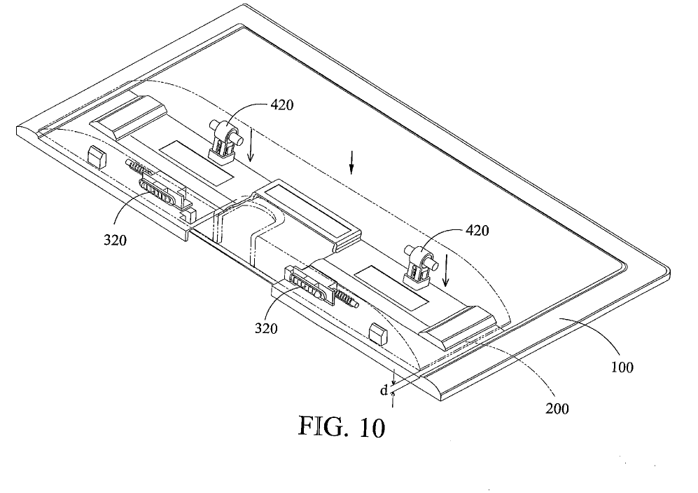

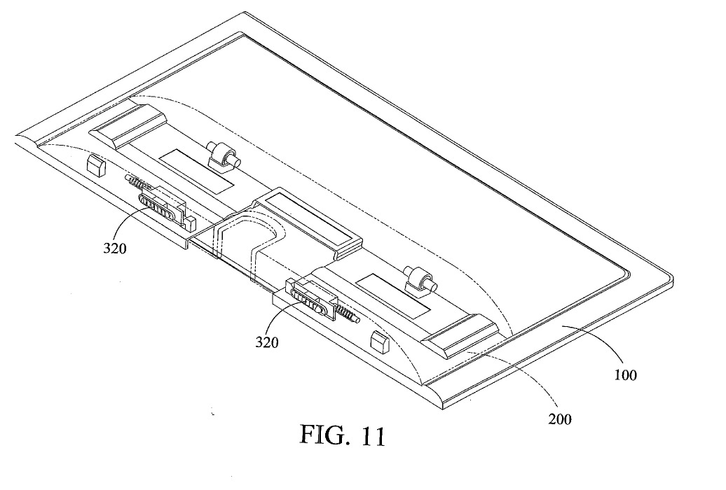

When the cover 200 is to be closed, the cover 200 is rotated with respect to the shaft 430 from the second position to the first position as shown in FIG. 10. The cover 200 is pressed to overcome the potential of the second spring 450 to enable the latching module 300 to engage the main body 100, whereby the cover 200 is closed as shown in FIG. 11.

Although a notebook computer is given as an example for the purposes of description, the invention is not limited thereto, other electronic devices, such as handheld game machines or personal digital assistants (PDA), are also applicable.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device, comprising
a main body;
a cover joined to the main body capable of opening and closing;
a latching module disposed on the cover and engaging the main body to close the cover;
an elevating-rotating mechanism connecting the main body and the cover, wherein when the latching module engages the main body, the cover is closed and fixed to the main body; when the latching module is released from the main body, the elevating-rotating mechanism lifts the cover from the main body to an appropriate distance and the cover is rotated by an appropriate angle with respect to the elevating-rotating mechanism.

2. The electronic device as claimed in claim 1, wherein the latching module comprises a first spring and a latching member having a hook and a first post to which the first spring is joined to bias the latching member and enable the hook to engage the main body.

3. The electronic device as claimed in claim 2, wherein the main body has a channel with which the hook engages.

4. The electronic device as claimed in claim 1, wherein the elevating-rotating mechanism comprises:
a base disposed on the main body;
a movable member movably disposed on the base;
a second spring biasing the movable member;
a shaft disposed on the movable member, moved with the movable member and joined to the cover rotating with respect to the shaft, wherein when the latching module is released from the main body, the second spring biases the movable member to move on the base and lift the cover to the appropriate distance, whereby the cover rotates to the appropriate angle with respect to the shaft.

5. The electronic device as claimed in claim 4, wherein the elevating-rotating mechanism further comprises a seat disposed on the movable member and has a second post to which the second spring is joined to bias the seat.

6. The electronic device as claimed in claim 4, wherein the base has an opening in which the movable member moves.

7. The electronic device as claimed in claim 6, wherein the cross section of the movable member has substantially the same profile as the opening.

8. The electronic device as claimed in claim 4, wherein the movable member has a curved portion, a linear portion connected to the curved portion and a flange projected from the linear portion, wherein the shaft is accommodated in the curved portion, and the linear portion is movably joined to the base, and the flange abuts the base to limit the movable member.

9. The electronic device as claimed in claim 8, wherein an opening is formed at the top of the base, and the linear portion is movably disposed in the opening.

10. The electronic device as claimed in claim 9, wherein the cross section of the linear portion substantially has the same profile as the opening.

11. The electronic device as claimed in claim 9, wherein the flange abuts the top of the base to limit the movable member.

12. The electronic device as claimed in claim 9, wherein the movable member moves in a direction perpendicular to the main body.

13. The electronic device as claimed in claim 8, wherein the elevating-rotating mechanism further comprises a seat disposed on the movable member and has a second post to which the second spring is joined to bias the seat.

14. The electronic device as claimed in claim 13, wherein the linear portion comprises a long groove having an end, and the seat further has a third post disposed in the long groove, and the second spring biases the seat to enable the third post to abut the end.
